(19) United States
(12) Patent Application Publication
(10) Pub. No.: US 2026/0029913 A1
(43) Pub. Date: Jan. 29, 2026

(54) MEMORY CONTROLLER AND DATA STORAGE SYSTEM

(71) Applicant: Hefei Kaimeng Technology Co., Ltd., Anhui (CN)

(72) Inventors: Ling Bo WANG, Anhui (CN); Yue HU, Anhui (CN); Dong Sheng RAO, Anhui (CN)

(73) Assignee: Hefei Kaimeng Technology Co., Ltd., Anhui (CN)

(21) Appl. No.: 19/069,187

(22) Filed: Mar. 3, 2025

(30) Foreign Application Priority Data
Jul. 23, 2024 (CN) 202410992024.3

(51) Int. Cl. G06F 3/06

(52) U.S. Cl. CPC G06F 3/0608; G06F 3/0634; G06F 3/0659; G06F 3/0679

(57) ABSTRACT

Provided are a memory controller and a data storage system. The memory controller is used to perform multiple steps. In response to a first parameter of a register being updated, a default mode is switched to a specified mode. A second parameter of the register is read to determine a specified threshold. State information of the physical cell is obtained according to the specified mode. If the state information of the physical cell meets the specified threshold, a data consolidation program is performed on the memory according to the specified mode. In this way, the memory controller operates in different modes in different situations to perform the data consolidation program.

### CROSS-REFERENCE TO RELATED APPLICATION

This application claims the priority benefit of China application serial no. 202410992024.3, filed on Jul. 23, 2024. The entirety of the above-mentioned patent application is hereby incorporated by reference herein and made a part of this specification.

### BACKGROUND

### Technical Field

The disclosure relates to a memory management technology, and more particularly, to a memory controller and a data storage system in which a data consolidation mode is determined by a host system.

### Description of Related Art

A non-volatile memory module (e.g., a flash memory module) has advantages such as non-volatile data storage, low power consumption, and fast data access. Generally speaking, some idle physical cells are configured by default in the non-volatile memory module to receive and store data from a host system. However, in a process of writing the data into the non-volatile memory module, a large amount of invalid data occupies a storage space in the used physical cells. In order to avoid the storage space being exhausted, garbage collection is generally performed to release the storage space for subsequent use.

However, a write speed of the host system will be reduced when performing the garbage collection, and an existing garbage collection strategy will affect read and write efficiency of a memory. How to ensure service quality of the memory is an issue of concern to those skilled in the art.

### SUMMARY

The disclosure provides a memory controller and a data storage system, in which a host system may select a data consolidation mode, and different data consolidation strategies may be selected in different scenarios to meet needs of a user.

An embodiment of the disclosure provides a memory controller electrically, which is connected to a memory and a register. The memory includes multiple physical cells. The memory controller is used to perform multiple steps. In response to a first parameter of the register being updated, a default mode is switched to a specified mode. A second parameter of the register is read to determine a specified threshold. State information of the physical cell is obtained according to the specified mode. If the state information of the physical cell meets the specified threshold, a data consolidation program is performed on the memory according to the specified mode.

From another perspective, an embodiment of the disclosure provides a data storage system, including a memory including multiple physical cells, a register including a first parameter and a second parameter, and a memory controller connected to a host system, the register, and the memory. The host system is used to perform multiple steps. State information of the physical cell in the memory is obtained according to data to be written. It is determined whether the memory meets a write condition for the data to be written according to the state information. If the write condition is not met, the mode command is transmitted to update the register to switch a default mode of the memory controller to a specified mode.

### BRIEF DESCRIPTION OF THE DRAWINGS

FIG. 1 is a schematic view of a data storage system according to an embodiment.

FIG. 2 is a schematic view of managing a memory module according to an embodiment.

FIG. 3 is a schematic view of a data consolidation program mode determined by a user according to an embodiment.

FIG. 4 is a schematic view of each of bits in a register according to an embodiment.

FIG. 5 is a schematic view of a data consolidation program in a second mode according to an embodiment.

FIG. 6 is a flow chart of a mode selection method for data consolidation according to an embodiment.

FIG. 7 is a flow chart of a mode selection method for data consolidation according to another embodiment.

### DETAILED DESCRIPTION OF DISCLOSED EMBODIMENTS

Reference will now be made in detail to the exemplary embodiments of the disclosure, and examples of the exemplary embodiments are illustrated in the accompanying drawings. Whenever possible, the same reference numerals are used in the drawings and descriptions to indicate the same or similar parts.

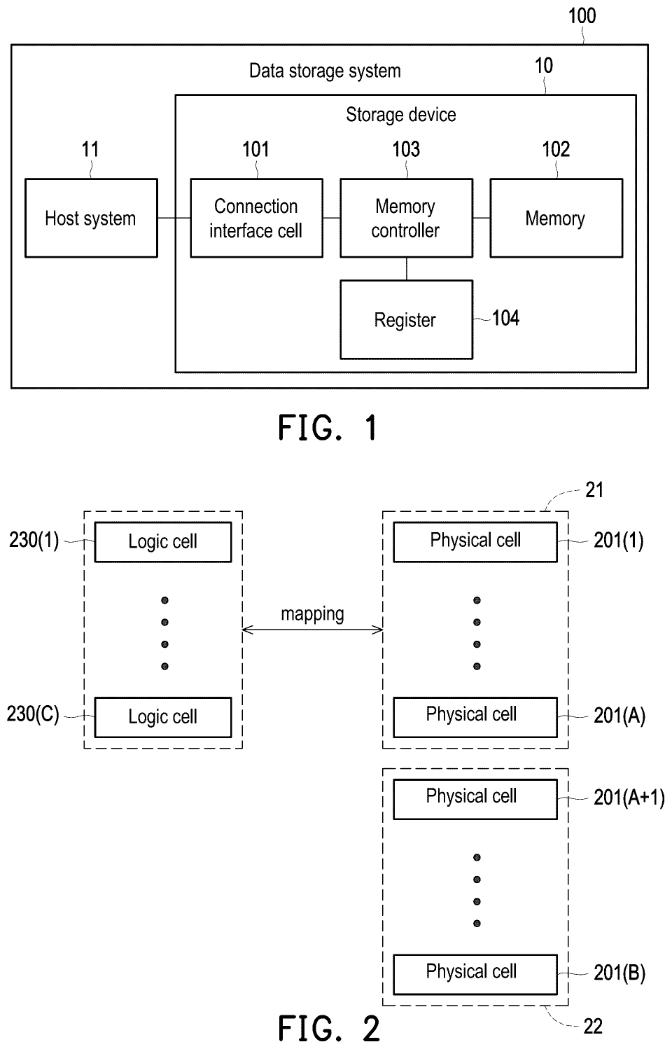

FIG. 1 is a schematic view of a data storage system according to an embodiment. Referring to FIG. 1, a data storage system 100 includes a storage device 10 and a host system 11. The host system 11 may be any types of computer systems, such as a smart phone, a tablet computer, a notebook computer, a desktop computer, an industrial computer, a game console, a server, or a vehicle computer, and a type of the host system 11 is not limited thereto.

The storage device 10 is connected to the host system 11 and is used to store data from the host system 11. For example, the storage device 10 may include a solid state drive, a USB flash drive, a memory card, or other types of non-volatile storage devices. The host system 11 may communicate with the storage device 10 through an embedded multi-media Card (eMMC), a universal flash storage (UFS), a peripheral component interconnect express (PCI Express), a non-volatile memory express (NVM express), a serial advanced technology attachment (SATA), a universal serial bus (USB), or other types of connection interface standards. Therefore, the host system 11 may store the data to the storage device 10 and/or read the data from the storage device 10.

The storage device 10 includes a connection interface cell 101, a memory 102, a memory controller 103, and a register 104. The connection interface cell 101 is used to connect the storage device 10 to the host system 11. For example, the connection interface cell 101 may support the connection interface standards such as eMMC, UFS, PCI Express, NVM express, SATA, PCI Express, or USB. The storage device 10 may communicate (e.g., exchange a signal and/or the data) with the host system 11 through the connection interface cell 101.

The memory 102 is used to store the data. The memory 102 may include one or more rewritable non-volatile memory modules. Each of the rewritable non-volatile memory modules may include one or more memory cell arrays. Memory cells in the memory cell array store the data in a form of voltage. For example, the memory 102 may include a single level cell (SLC) NAND flash memory module, a multi level cell (MLC) NAND flash memory module, a triple level cell (TLC) NAND flash memory module, a quad level cell (QLC) NAND flash memory module, and/or other memory modules having the same or similar characteristics.

The memory controller 103 is connected to the connection interface cell 101, the register 104, and the memory 102. The memory controller 103 may be regarded as a control core of the storage device 10 and is used to control the storage device 10. For example, the memory controller 103 may be responsible for controlling and/or managing overall or partial operations of the storage device 10. For example, the memory controller 103 may include a central processing unit (CPU), or other programmable general-purpose or special-purpose microprocessors, digital signal processors (DSP), programmable controllers, application specific integrated circuits (ASIC), programmable logic devices (PLD), or other similar devices or a combination of the devices. In an embodiment, the memory controller 103 includes a flash memory controller.

The register 104 is used to implement specific functions, which are some small storage areas for temporarily storing codes and commands inside the storage device 10. For example, the register 104 may include a card identification register (CID), a card specific data register (CSD), a SD card configuration register (SCR), and an operating conditions register (OCR). In an embodiment, the register 104 includes the CSD register. In an embodiment, the memory controller 103 may further include a buffer memory, a power management circuit, an encoding circuit, a decoding circuit, and/or other types of various circuit modules, and the disclosure is not limited thereto. The buffer memory is used to cache the data. The power management circuit is used to manage a power of the storage device 10. The encoding circuit is used to encode the data to be stored in the memory 102 to generate an error correction code (and/or an error check code). The decoding circuit is used to decode the data read from the memory 102 to correct possible errors in the read data. For example, the encoding circuit and/or decoding circuit may encode and decode the data by using various encoding/decoding algorithms such as a low density parity check code (LDPC code), BCH code, Reed-solomon code (RS code), exclusive OR (XOR) code.

The memory 102 may receive a command sequence from the memory controller 103 and access the memory cells according to the command sequence. For example, when the data is to be stored, the memory controller 103 may send a write command sequence to the memory 102 to instruct the memory 102 to store the data in a specific memory cell. When the data is to be read, the memory controller 103 may send a read command sequence to the memory 102 to instruct the memory 102 to read the data from a specific memory cell. When the data is to be deleted, the memory controller 103 may send an erase command sequence to the memory 102 to instruct the memory 102 to erase the data stored in a specific memory cell. In addition, the memory controller 103 may further send other types of command sequences to the memory 102 to instruct the memory 102 to perform corresponding operations, and the disclosure is not limited thereto.

FIG. 2 is a schematic view of managing a memory module according to an embodiment. Referring to FIGS. 1 and 2, the memory 102 includes multiple physical cells 201(1) to 201(B). Each of the physical cells includes multiple memory cells and is used to store the data in a non-volatile manner.

In an embodiment, one physical cell may include multiple physical sectors. For example, a data capacity of one physical sector may be 512 bytes (B), and one physical cell may include 8 physical sectors. However, the data capacity of one physical sector and/or the total number of physical sectors included in one physical cell may be adjusted according to practical requirements, and the disclosure is not limited thereto. In an embodiment, one physical cell may be regarded as one physical page. For example, a data capacity of one physical page may be 4 kilobytes (4 KB), but the disclosure is not limited thereto.

In an embodiment, one physical page is a minimum unit for synchronously writing the data in the memory 102. For example, when a programming operation is performed on one physical page to write the data into the physical page, multiple memory cells in the physical page may be programmed synchronously to store the corresponding data. For example, when one physical page is programmed, a write voltage may be applied to the physical page to change threshold voltages of at least some of the memory cells in the physical page. The threshold voltage of each of the memory cells may reflect bit data stored in the memory cell.

In an embodiment, the memory 102 may include multiple physical blocks. Each of the physical blocks may include multiple physical cells. In particular, the physical cells (e.g., the physical pages) in the same physical block may be erased simultaneously. For example, when one physical block is erased, an erase voltage may be applied to the physical pages in the physical block to change the threshold voltages of at least some of the memory cells in the physical pages and clear the bit data stored in each of the memory cells in the physical pages.

In an embodiment, the memory controller 103 may logically associate the physical cells 201(1) to 201(A) with a data area 21 and associate the physical cells 201(A+1) to 201(B) with a spare area 22. The physical cells 201(1) to 201(A) in the data area 21 are used to store the data (also referred to as user data) from the host system 11. For example, each of the physical cells in the data area 21 may store valid data and/or invalid data. In addition, the physical cells 201(A+1) to 201(B) in the spare area 22 do not store the data.

In an embodiment, if one certain physical cell does not store the valid data, the physical cell may be associated with the spare area 22. In an embodiment, the spare area 22 is also called a free pool, and the physical cells in the spare area 22 are also called free physical cells. In addition, the physical cell associated with the spare area 22 may be erased to clear the data in the physical cell.

In an embodiment, when the data (i.e., the user data) from the host system 11 is required to be stored, the memory controller 103 may select one or more physical cells from the spare area 22 and instruct the memory 102 to store the data from the host system 11 into the selected physical cells. At the same time, the selected physical cells may be associated with the data area 21.

In an embodiment, the memory controller 103 may be provided with multiple logic cells 230(1) to 230(C) to map the physical cells 201(1) to 201(A) in the data area 21. For example, one logic cell may correspond to one logical block address (LBA) or other logical management units (such as one logical page). One logic cell may be mapped to one or more physical cells in the data area 21.

In an embodiment, if one certain physical cell is currently mapped by any one of the logic cells, the memory controller 103 may determine that the data currently stored in the physical cell includes the valid data. On the contrary, if one certain physical cell is not currently mapped by any logic cell, the memory controller 103 may determine that the physical cell does not currently store any valid data (and/or the data in the physical cell are all the invalid data).

In an embodiment, the memory controller 103 may record a mapping relationship between the logic cell and the physical cell in a logic-to-physical mapping table. When receiving an access command (such as a read command, a write command, a delete command, or other types of commands) from the host system 11, the memory controller 103 may instruct the memory 102 to perform a corresponding operation behavior according to information in the logic-to-physical mapping table.

The memory controller 103 may perform a data consolidation program according to requirements. The data consolidation program is also called a garbage collection program. When performing the data consolidation program, the memory controller 103 may select at least one of the physical cells from the data area 21 as a source physical cell and select at least one of the physical cells from the spare area 22 as a target physical cell. The memory controller 103 may centrally copy the valid data stored in the source physical cell to the target physical cell. After the valid data stored in the source physical cell is copied to the target physical cell, all the data in the source physical cell will be marked as invalid, and the source physical cell may be divided into the spare area 22. In addition, the physical cell divided into the spare area 22 may be erased to clear the data stored in the physical cell. In an embodiment, an operation of re-dividing one certain physical cell from the data area 21 to the spare area 22 is also called releasing one physical cell. That is, during the initiation of the data consolidation program, one or more physical cells may be gradually released, and the total number of physical cells belonging to the spare area 22 may gradually increase. In addition, the physical cells that do not store the valid data are called the free physical cells.

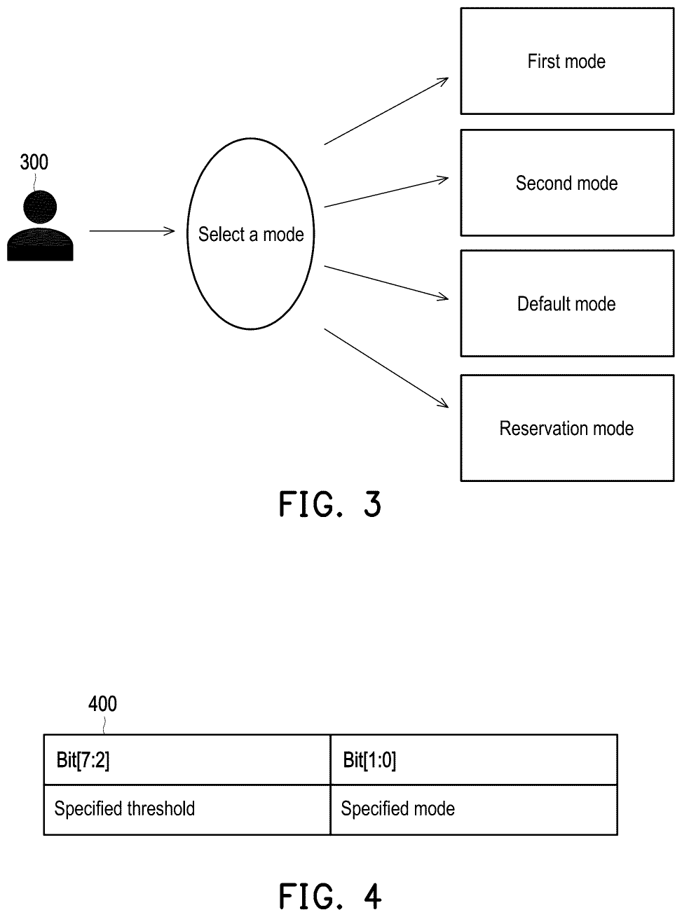

In particular, in this embodiment, there are multiple modes for performing the data consolidation program, and the host system 11 may specify which of the modes to use. FIG. 3 is a schematic view of a data consolidation program mode determined by a user according to an embodiment. Referring to FIG. 3, a user 300 may operate a user window on the host system 11, and in the user window, multiple options may be provided for the user 300 to choose from. For example, the host system 11 may directly display all the selectable modes on the user window, allow the user to input what operation he wants to perform at present (for example, he wants to write a large-capacity file), or allow the user to input whether he prefers performance or service life. According to the input of the user, the host system 11 transmits a mode command to the storage device 10. In the embodiment of FIG. 3, there are four modes, namely, a first mode, a second mode, a default mode, and a reservation mode, which are also referred to as preset modes. In different preset modes, the storage device 10 will perform the data consolidation program with different strategies. The mode commands and operations of the different preset modes will be described in detail below.

Referring to FIG. 1, in an embodiment, the memory controller 103 is electrically connected to the register 104, and modifies the register 104 according to the mode command obtained from the connection interface cell 101. For example, when the connection interface cell 101 supports the eMMC standard, the register 104 may be an EXT-CSD register. A size of the EXT-CSD register is 512 bytes, of which 320 bytes are an attribute segment, which defines a function of the register and may not be modified by the host system 11. The other 192 bytes are a mode segment, which defines task allocation of the register, and some of the bytes may be modified by the host system 11. For example, the host system 11 may modify the content in the EXT-CSD register through a SWITCH command. When the connection interface cell 101 supports other standards (such as UFS), a modifiable register therein may also be used. A name of the used register may not be EXT-CSD but may have other names, and the disclosure does not limit which register is to be used. In other embodiments, the host system 11 may also directly transmit the mode command to the memory controller 103, but the disclosure is not limited thereto.

FIG. 4 is a schematic view of each of bits in a register according to an embodiment. Referring to FIG. 4, in this example, a table 400 is used to present 8 bits in the register 104, and the 8 bits indicate a mode state. The register 104 includes two parameters, which are a first parameter and a second parameter respectively. In this example, the two lower bits Bit [1:0] read from the register 104 are used as the first parameter. The first parameter is used to determine a specified mode. The 6 higher bits Bit [7:2] are the second parameter, and the second parameter is used to determine a specified threshold.

In this embodiment, there are 4 preset modes. When a value represented by the bit Bit [1:0] is 1, it corresponds to the first mode. When the value represented by the bit Bit [1:0] is 2, it corresponds to the second mode. When the value represented by the bit Bit [1:0] is 0, it corresponds to the default mode. When the value represented by the bit Bit [1:0] is 3, it corresponds to the reservation mode. The memory controller 103 may read the bit Bit [1:0] from the register 104 to obtain the corresponding specified mode. In other embodiments, different first parameters may correspond to other preset modes. When the number of preset modes is greater, more bits may be used as the first parameter.

The second parameter is used to determine the specified threshold. Since only the 6 bits Bit [7:2] may be used to determine the specified threshold, the values represented by the 6 bits are in a range of 0 to 63, which covers a smaller range of values. If the bit is increased, an additional byte is required. Therefore, in an embodiment, the values represented by the bits Bit [7:2] read from the register 104 may be multiplied by a ratio to serve as the specified threshold. The ratio is, for example, 2, but may also be 3 or other values in other embodiments. For example, if the value represented by the bit Bit [7:2] is 20, and the ratio is 2, then the specified threshold is equal to 20*2=40. This approach may cover a wider range of values while using less register space.

In an embodiment, more bits may be used as the second parameter, and the number of specified thresholds may be greater than one. For example, if two specified thresholds are used to represent one range, multiple bits in the register may be used to generate a lower limit of the range, and the other bits may be used to generate an upper limit of the range. The values represented by the bits may also be multiplied by the ratio to obtain the corresponding lower limit or upper limit, and the ratios used for the lower limit and the upper limit may be different.

Generally, the memory controller 103 operates in the default mode. After the host system 11 transmits the mode command to the storage device 10, the memory controller 103 receives the mode command to modify the register 104, and updates the first parameter and the second parameter in the register 104. When the first parameter is updated, it indicates that the host system 11 is about to switch the mode, so the memory controller 103 switches the default mode to the specified mode. The specified mode is determined by the first parameter. The bits in the first parameter are used to select one of the preset modes as the specified mode. That is, the specified mode belongs to one of the preset modes. In different specified modes, the memory controller 103 will obtain different state information about the physical cells. The state information includes, for example, the amount (or percentage) of the valid data in the physical cell, capacities of all the free physical cells, the number of times each of the physical cells is erased, the update frequency of the valid data in the physical cell, the dispersion degree of the valid data in the physical cell, etc., but the disclosure is not limited thereto.

When the specified mode belongs to the first mode, the memory controller 103 may obtain first state information. When the specified mode belongs to the second mode, second state information is obtained. When the specified mode belongs to the default mode, third state information is obtained. The first state information, the second state information, and the third state information are different from each other. Different state information reflects different data consolidation strategies. Some strategies may be designed to quickly generate a small number of free physical cells, some strategies may be designed to generate a large number of free physical cells at one time, and some strategies may be designed to extend service life of the storage device 10. By obtaining different state information, objectives of the user may be better met.

When the specified mode belongs to the default mode, the memory controller 103 obtains third state information according to the default mode, and the third state information includes remaining storage spaces of all the physical cells. The memory controller 103 determines whether the remaining storage space is less than the specified threshold. If yes, the data consolidation program is performed until the remaining storage space is not less than the specified threshold. In some embodiments, the remaining storage space may be expressed as a percentage of all the storage spaces. For example, if storage capacities of all the physical cells is 100 GB, and the remaining storage space is 3 GB, it may be expressed as 3/100-3%.

In an embodiment, when the specified mode belongs to the first mode, the obtained first state information includes a proportion of the valid data in each of the physical cells. In this mode, it is determined whether the proportion of the valid data in each of the physical cells is less than the specified threshold. If yes, the corresponding physical cell is marked. Next, the data consolidation program is performed on the marked physical cell first. That is, the marked physical cell is regarded as the source physical cell, and the valid data therein is moved to the target physical cell. The setting of the specified threshold affects which of the physical cells to be marked. When the specified threshold is smaller (for example, between 10 and 30), it indicates that there is very little valid data in the marked physical cell. Performing the data consolidation program first on the physical cells may quickly release the physical cells and generate the free physical cells. After the data consolidation program performed on the marked physical cell is completed, other physical cells may be may selected according to a default logic to continue to perform the data consolidation program, or the data consolidation program may interrupted. However, the disclosure is not limited thereto.

In an embodiment, when the specified mode belongs to the second mode, the obtained second state information includes the capacity of the free physical cell, and the value may be expressed as a percentage. For example, if the capacity of the free physical cell is 50 GB, and the storage capacities of all the physical cells are 100 GB, then 50/100=50% is used to represent the capacity of the free physical cell. In another embodiment, the capacity of the free physical cell may also be represented by the number of free physical cells. In this mode, it is determined whether the capacity of the free physical cell is less than the specified threshold. If yes, the data consolidation program is performed until the capacity of the free physical cell is not less than the specified threshold. This mode allows the user to start the data consolidation program according to the requirements to release more free physical cells. For example, when a large file data is required to be written, since the file data is required to be written sequentially, a lot of continuous storage spaces are required. When there are a lot of fragmented storage spaces in the memory, garbage collection of the default mode is not currently triggered, but there is not enough continuous storage space to perform continuous writing of large files. Therefore, before writing the large files, the specified mode is set to the second mode, and the capacity of the free physical cell in the specified threshold is set to a larger value, so that enough storage space may be arranged to sequentially write the large file data.

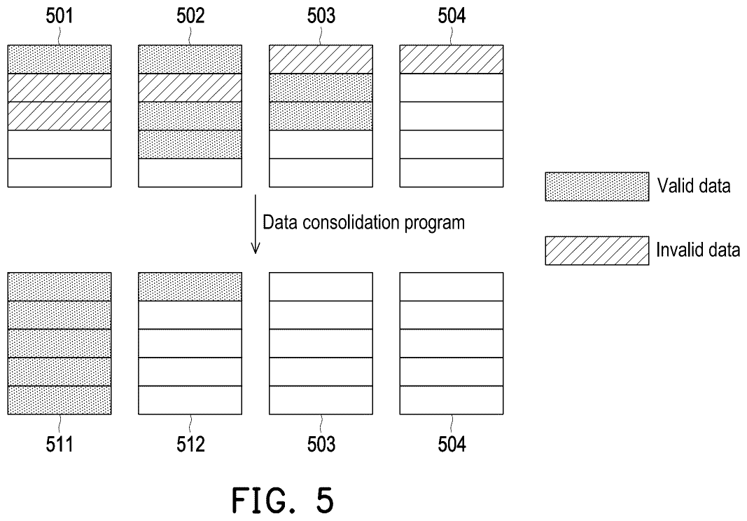

FIG. 5 is a schematic view of a data consolidation program in a second mode according to an embodiment. Referring to FIG. 5, here, physical cells 501 to 504 are shown. The physical cells 501 to 503 include the valid data and the invalid data, and the physical cell 504 includes the invalid data. Each of the physical cells 501 to 504 has some small fragmented storage spaces. When the host system 11 is required to write a large amount of data to be written and requires sequential writing, although the physical cells 501 to 504 have enough space to store the data to be written, the continuous storage space is insufficient. In the default mode, since the remaining storage space is greater than the specified threshold in the default mode, the data consolidation program may not be triggered to release new physical cells. Therefore, the first parameter of the register 104 may be modified to perform the second mode, and the capacity of the free physical cell is used as a condition for triggering the data consolidation program. After the data consolidation program is performed, the valid data is stored in the physical cells 511 and 512, and the physical cells 503 and 504 become the free physical cells. At this time, there are enough free physical cells to meet requirements of sequential writing.

In an embodiment, when the specified mode belongs to the first mode or the second mode, the mode will be switched to the default mode after the data consolidation program is completed. Since the data consolidation program is performed according to the proportion of the valid data in the first mode, many free physical cells have been released after the implementation. If the first mode is maintained, the data consolidation program will continue to be performed even when there are sufficient free physical units, which causes unnecessary data movement. Switching to the default mode may avoid such a phenomenon. In addition, in the second mode, the capacity of the free physical cell is used to determine whether to perform the data consolidation program. Similarly, if the second mode is maintained, the data consolidation program may be continuously performed when the specified threshold is large, or the data consolidation program may not be performed when the specified threshold is small. Switching to the default mode may avoid such a phenomenon.

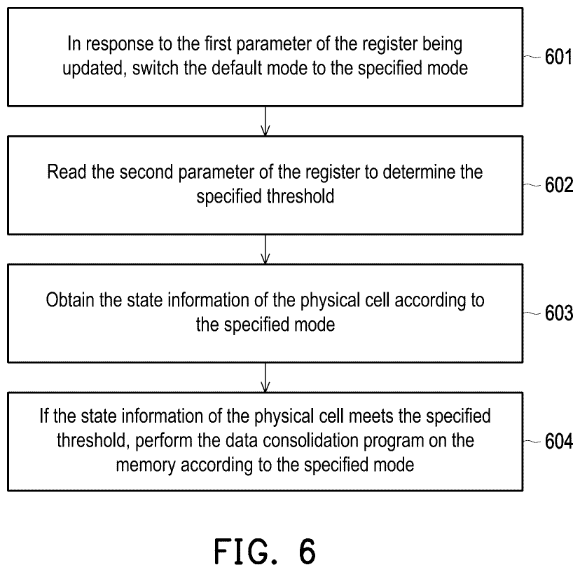

FIG. 6 is a flow chart of a mode selection method for data consolidation according to an embodiment. Referring to FIG. 6, steps 601 to 604 are performed by the memory controller 103. Therefore, the same details will not be repeated in the following.

In step 601, in response to the first parameter of the register 104 being updated, the default mode is switched to the specified mode. In step 602, the second parameter of the register 104 is read to determine the specified threshold. In step 603, the state information of the physical cell is obtained according to the specified mode. The first parameter, the default mode, the second parameter, the specified threshold, the specified mode, and the state information have been described in detail above. Therefore, the same details will not be repeated in the following.

In step 604, if the state information of the physical cell meets the specified threshold, the data consolidation program is performed on the memory according to the specified mode. Here, “meeting the specified threshold” may mean less than, equal to, or greater than the specified threshold, or when the specified threshold represents a range, “meeting the specified threshold” may mean within or outside the range. Since the state information of the physical cell is obtained according to the specified mode, when the state information meets the specified threshold, it also represents different situations. At this time, the data consolidation program may be performed according to the specified mode. Some attributes of the data consolidation program (e.g., an order, time, source, or target) may be different in different modes.

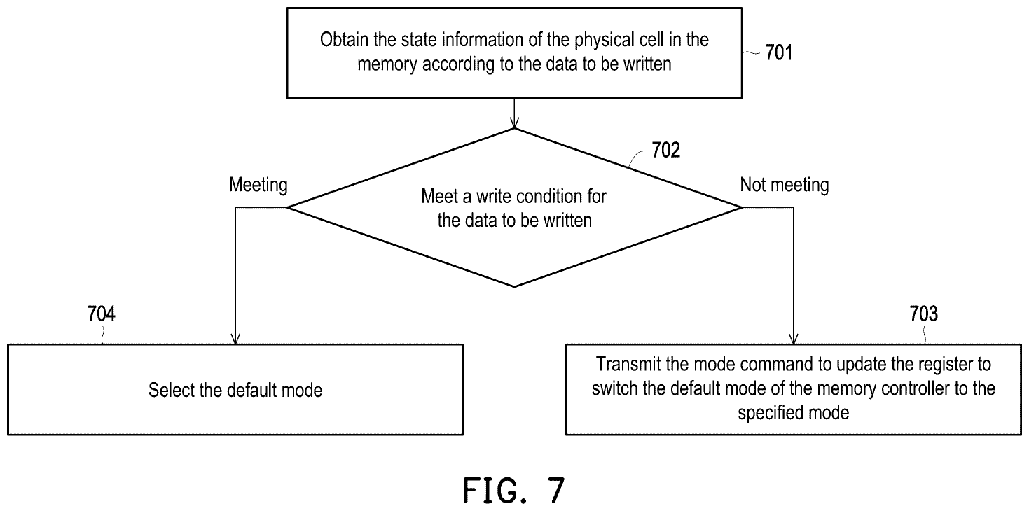

In the above embodiment, the user decides which mode to switch to, but in other embodiments, the host system 11 may independently decide which mode to switch to. FIG. 7 is a flow chart of a mode selection method for data consolidation according to another embodiment. Referring to FIG. 7, steps 701 to 704 are performed by the host system 11. Therefore, the same details will not be repeated in the following.

In step 701, the state information of the physical cell in the memory is obtained according to the data to be written. When characteristics of the data to be written (e.g., a data size, whether to be written sequentially, the number of data to be written, etc.) are different, the host system 11 will select different preset modes. Therefore, different state information will be obtained.

In step 702, it is determined whether the memory meets a write condition for the data to be written according to the state information. For example, the write condition for the data to be written includes whether the memory includes sufficient continuous writing space, or the write condition may also be whether the memory includes sufficient storage space (not necessarily continuous).

If the write condition is not met, in step 703, the mode command is transmitted to update the register 104 to switch the default mode of the memory controller 103 to the specified mode. Generally speaking, the memory controller 103 operates in the default mode. When the write condition is not met, it means that the default mode is not suitable for the data to be written, so the mode is required to be converted to the specified mode.

If the write condition is met, in step 704, the default mode is selected. For example, the mode command is transmitted to update the register 104 to switch the memory controller 103 from other modes to the default mode. In addition, the mode command may not be transmitted, so that the memory controller 103 operates in the default mode.

For example, when there are multiple consecutive data to be written, if the current remaining storage space is close to the threshold, the data consolidation program may be repeatedly triggered during a writing process, affecting a speed of writing the data. To avoid this situation, it is appropriate to switch to the first mode at this time to obtain the used storage spaces of all the physical cells in the memory. When a sum of the used storage spaces and the storage space required for the multiple data to be written is greater than the specified threshold, the host system 11 transmits the mode command to update the first parameter and the second parameter of the register 104, so that the first parameter is a first preset value to switch the default mode of the memory controller 103 to the first mode. In the first mode, the proportion of the valid data of the physical cell is used as the condition to trigger the data consolidation. The physical cells with less valid data may be collected first, which may release a lot of storage spaces more quickly than the default mode.

In addition, when the data to be written is written sequentially, a lot of continuous storage spaces are required, such as the situation in FIG. 5. At this time, the second mode is suitable for this situation. Therefore, the host system 11 obtains the capacity of the free physical cell of the memory 102. In response to the capacity of the free physical cell being less than the data to be written, the host system 11 transmits the mode command to update the first parameter and the second parameter of the register 104, so that the first parameter is a second preset value to switch the default mode of the memory controller 103 to the second mode.

Through the above method and storage device, the host system may decide the data consolidation mode by itself in some special scenarios, avoiding a situation where the performance of the storage device is reduced or the storage device may not operate normally in the scenarios. In addition, the user may adjust the data consolidation program according to their needs and preferences, or adjust the specified threshold. In this way, the user may choose different collection strategies to balance device life and performance, and use the optimal garbage collection strategy even in special scenarios.

Lastly, it is to be noted that: the embodiments described above are only used to illustrate the technical solutions of the disclosure, and not to limit the disclosure; although the disclosure is described in detail with reference to the embodiments, those skilled in the art should understand: it is still possible to modify the technical solutions recorded in the embodiments, or to equivalently replace some or all of the technical features; the modifications or replacements do not cause the essence of the corresponding technical solutions to deviate from the scope of the technical solutions of the embodiments.

What is claimed is:

1. A memory controller electrically connected to a memory and a register, wherein the memory comprises a plurality of physical cells, and the memory controller is used to perform a plurality of steps:
in response to a first parameter of the register being updated, switching a default mode to a specified mode;
reading a second parameter of the register to determine a specified threshold;
obtaining state information of the physical cell according to the specified mode; and
if the state information of the physical cell meets the specified threshold, performing a data consolidation program on the memory according to the specified mode.

2. The memory controller according to claim 1, wherein the performed step further comprises:
receiving a mode command to modify the register, and updating the first parameter and the second parameter of the register.

3. The memory controller according to claim 1, wherein the specified mode belongs to one of a plurality of preset modes, the preset modes comprise a first mode, a second mode, and the default mode, and the step of obtaining the state information of the physical cell according to the specified mode comprises:
when the first parameter is a first preset value, and the specified mode belongs to the first mode, obtaining first state information;
when the first parameter is a second preset value, and the specified mode belongs to the second mode, obtaining second state information; and
when the first parameter is a third preset value, and the specified mode belongs to the default mode, obtaining third state information, wherein the first state information, the second state information, and the third state information are different from each other.

4. The memory controller according to claim 1, wherein after the step of performing the data consolidation program according to the specified mode, the step further comprises:
after performing the data consolidation program, switching back to the default mode.

5. The memory controller according to claim 3, wherein the first state information comprises a percentage of valid data in each of the physical cells, and the step of performing the data consolidation program according to the specified mode comprises:
when the specified mode belongs to the first mode, determining whether the proportion of the valid data is less than the specified threshold; and
if yes, marking the corresponding physical cell, and performing the data consolidation program on the marked physical cell.

6. The memory controller according to claim 3, wherein the second state information comprises a capacity of a free physical cell, wherein the step of performing the data consolidation program according to the specified mode comprises:
when the specified mode belongs to the second mode, determining whether the capacity of the free physical cell is less than the specified threshold; and
if yes, performing the data consolidation program until the capacity of the free physical cell is not less than the specified threshold.

7. The memory controller according to claim 1, wherein when in the default mode, the steps further comprises:
obtaining third state information of the physical cell according to the default mode, wherein the third state information comprises a remaining storage space of all the physical cells;
determining whether the remaining storage space is less than a default threshold; and
if yes, performing the data consolidation program until the remaining storage space is not less than the default threshold.

8. A data storage system, comprising:
a memory comprising a plurality of physical cells;
a register comprising a first parameter and a second parameter and receiving a mode command to modify the first parameter and the second parameter; and
a memory controller connected to a host system, the register, and the memory,
wherein the host system is used to perform a plurality of steps:
obtaining state information of the physical cell in the memory according to data to be written;
determining whether the memory meets a write condition for the data to be written according to the state information; and
if the write condition is not met, transmitting the mode command to update the register to switch a default mode of the memory controller to a specified mode.

9. The data storage system according to claim 8, wherein the steps comprises:
when there are a plurality of consecutive data to be written, obtaining a used storage space of all the physical cells of the memory;
in response to a sum of the used storage space and a storage space required for the plurality of data to be written being greater than a specified threshold, transmitting the mode command to update the first parameter and the second parameter of the register, wherein
the first parameter of the register is updated to a first preset value, so as to switch the default mode of the memory controller to a first mode.

10. The data storage system according to claim 8, wherein the steps comprises:
when the data to be written is sequentially written, obtaining a capacity of a free physical cell of the memory;
in response to the capacity of the free physical cell being less than the data to be written, transmitting the mode command to update the first parameter and the second parameter of the register; and
updating the first parameter of the register to a second preset value to switch the default mode of the memory controller to a second mode.

11. The data storage system according to claim 8, wherein the memory controller is used to perform a plurality of steps, comprising:
in response to the first parameter of the register being updated, switching the default mode to the specified mode;
reading the second parameter of the register to determine a specified threshold;
obtaining the state information of the physical cell according to the specified mode; and
if the state information of the physical cell meets the specified threshold, performing a data consolidation program on the memory according to the specified mode.

12. The data storage system according to claim 11, wherein the step performed by the memory controller further comprises:
receiving the mode command to modify the register, and updating the first parameter and the second parameter of the register.

13. The data storage system according to claim 11, wherein the specified mode belongs to one of a plurality of preset modes, the preset modes comprise a first mode, a second mode, and the default mode, and the step of obtaining the state information of the physical cell according to the specified mode comprises:
when the first parameter is a first preset value, and the specified mode belongs to the first mode, obtaining first state information;
when the first parameter is a second preset value, and the specified mode belongs to the second mode, obtaining second state information; and
when the first parameter is a third preset value, and the specified mode belongs to the default mode, obtaining third state information, wherein the first state information, the second state information, and the third state information are different from each other.

14. The data storage system according to claim 11, wherein after the step of performing the data consolidation program according to the specified mode, the steps performed by the memory controller further comprise:
after performing the data consolidation program, switching back to the default mode.

15. The data storage system according to claim 13, wherein the first state information comprises a percentage of valid data in each of the physical cells, and the step of performing the data consolidation program according to the specified mode comprises:
when the specified mode belongs to the first mode, determining whether the proportion of the valid data is less than the specified threshold; and
if yes, marking the corresponding physical cell, and performing the data consolidation program on the marked physical cell.

16. The data storage system according to claim 13, wherein the second state information comprises a capacity of a free physical cell, wherein the step of performing the data consolidation program according to the specified mode comprises:
when the specified mode belongs to the second mode, determining whether the capacity of the free physical cell is less than the specified threshold; and
if yes, performing the data consolidation program until the capacity of the free physical cell is not less than the specified threshold.

17. The data storage system according to claim 11, wherein when the memory controller is in the default mode, the step performed by the memory controller further comprises:
obtaining third state information of the physical cell according to the default mode, wherein the third state information comprising a remaining storage space of all the physical cells;
determining whether the remaining storage space is less than the specified threshold; and
if yes, performing the data consolidation program until the remaining storage space is not less than the specified threshold.
